(19) United States
(12) Patent Application Publication
(10) Pub. No.: US 2025/0346820 A1
(43) Pub. Date: Nov. 13, 2025

(54) ENHANCING LIGHT OILEFINS YIELD IN CRUDE OIL REFINING WITH STEAM CRACKING RECYCLING AND DEEP HYDROGENATION

(71) Applicant: Saudi Arabian Oil Company, Dhahran (SA)

(72) Inventors: Ashok Kumar Punetha, Dhahran (SA); Omer Refa Koseoglu, Dhahran (SA)

(21) Appl. No.: 18/659,139

(22) Filed: May 9, 2024

(51) Int. Cl. C10G 69/04; B01D 3/10; B01D 3/14; B01J 8/04; C10G 9/36; C10G 49/08

(52) U.S. Cl. CPC C10G 69/04; B01D 3/10; B01D 3/143; B01J 8/0492; C10G 9/36; C10G 49/08; C10G 2300/1044; C10G 2300/1059; C10G 2300/1074

(57) ABSTRACT

Crude oil obtained from a subterranean formation is fractionated to separate an atmospheric residue stream from the crude oil. At least a portion of the atmospheric residue stream is fractionated to separate a vacuum residue stream from the atmospheric residue stream. A feedstock including the vacuum residue stream, a second portion of the atmospheric residue stream, or both are upgraded to produce a middle distillate stream. At least a portion of the middle distillate stream is hydrogenated to produce a hydrogenated stream. Carbon-carbon bonds of the hydrogenated stream are broken in the presence of steam to produce a mixed gas product including light olefins and a liquid product. The liquid product is recycled to deep hydrogenation.

### TECHNICAL FIELD

This disclosure relates to hydrocarbon refining, and in particular, crude oil refining.

### BACKGROUND

After raw hydrocarbons are extracted from a reservoir, the hydrocarbons can be refined to produce commercial fuels and other products. Hydrocarbons extracted from a reservoir can contain various impurities. Hydrocarbon refining processes are chemical engineering processes used in refineries to transform raw hydrocarbons into the various products, for example, liquefied petroleum gas (LPG), gasoline, kerosene, jet fuel, diesel oils, fuel oils, and other products. The hydrocarbon refining processes can include processes that remove such impurities from the raw hydrocarbons, for example, before the hydrocarbons are transformed into the various products mentioned previously. Refineries are large industrial complexes that involve many different processing units and auxiliary facilities, for example, utility units, storage tanks, and other auxiliary facilities. Each refinery can have its own unique arrangement and combination of refining processes determined, for example, by the refinery location, desired products, economic considerations, or other factors.

### SUMMARY

This disclosure describes technologies relating to hydrocarbon refining, and in particular, crude oil refining. The subject matter described in this disclosure can be implemented in particular implementations, so as to realize one or more of the following advantages. The described processes and systems recycle heavier products (for example, liquid products) from the steam cracking unit, allowing for a bottomless steam cracking process that yields additional light olefins. For example, pyrolysis gasoline and pyrolysis oil from the steam cracking unit is recycled to a hydroprocessing unit for further deep hydrogenation in preparation to be recycled to the steam cracking unit to produce additional light olefins. The described processes and systems include deep distillate hydrogenation to deeply hydrogenate various process streams, such as pyrolysis gasoline to produce additional feedstock for the steam cracking unit. The deep distillate hydrogenation included in the described processes and systems can fully saturate aromatics to naphthenes and paraffins to increase light olefin yield of the steam cracking unit. The deep hydrogenation can allow for recycling and generation of additional feedstock for steam cracking, which in turn increases production of light olefins. The described processes and systems can, for example, maximize ethylene production in crude oil refineries. The described processes and systems can mitigate and/or eliminate steam cracking by-product production by recycle of heavier products within the system. The described processes and systems can minimize production of heavy fuels while maximizing olefin production, which can increase overall profits. As demand for distillate fuel declines, the described processes and systems can process distillates to produce economically viable products which can, for example, be sold on the market.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example system for refining crude oil obtained from a subterranean formation.

FIG. 2 is a flow chart of an example method for refining crude oil obtained from a subterranean formation.

### DETAILED DESCRIPTION

This disclosure describes processes and systems for increasing light olefins production in hydrocarbon refining including steam cracking. Steam cracking can involve breaking of carbon-carbon bonds of saturated hydrocarbons in the presence of steam to produce smaller hydrocarbons (often unsaturated hydrocarbons). Saturated hydrocarbons are hydrocarbons that include only single bond(s) between carbon atoms. Unsaturated hydrocarbons are hydrocarbons that include at least one non-single (e.g., double or triple) bond between carbon atoms. The system includes a deep hydrogenation unit that is configured to deeply hydrogenate hydrocarbons (e.g., saturate aromatics with hydrogens) to produce additional feedstock (saturated hydrocarbons, such as naphthenes and paraffins) to the steam cracking unit. The steam cracking unit produces a mixed gas product stream including light olefins. The steam cracking unit can produce pyrolysis gasoline and pyrolysis oil. Steam cracking liquid products (such as pyrolysis gasoline and/or pyrolysis oil) are recycled back to the deep hydrogenation unit for further deep hydrogenation to produce distillate, which can include naphtha. The distillate is then sent back to the steam cracking unit. Pyrolysis gasoline produced in the steam cracking unit is recycled to a hydrodesulfurization (also referred to as hydrotreating) and/or deep hydrogenation unit for full saturation of aromatics. Hydrotreating involves a catalytic chemical process used to remove sulfur and nitrogen from natural gas and refined petroleum products (such as gasoline, jet fuel, kerosene, diesel fuel, and fuel oils). The deeply hydrogenated stream is flowed from the deep hydrogenation unit to the steam cracking unit to produce ethylene. Further, pyrolysis oil is recycled from the steam cracking unit to a residue upgrading unit for further processing. The recycling of various streams within the system allows for a bottomless steam cracking process (for example, a steam cracking process that does not generate a net output of liquid products because the liquid products generated by the steam cracking process is recycled within the system).

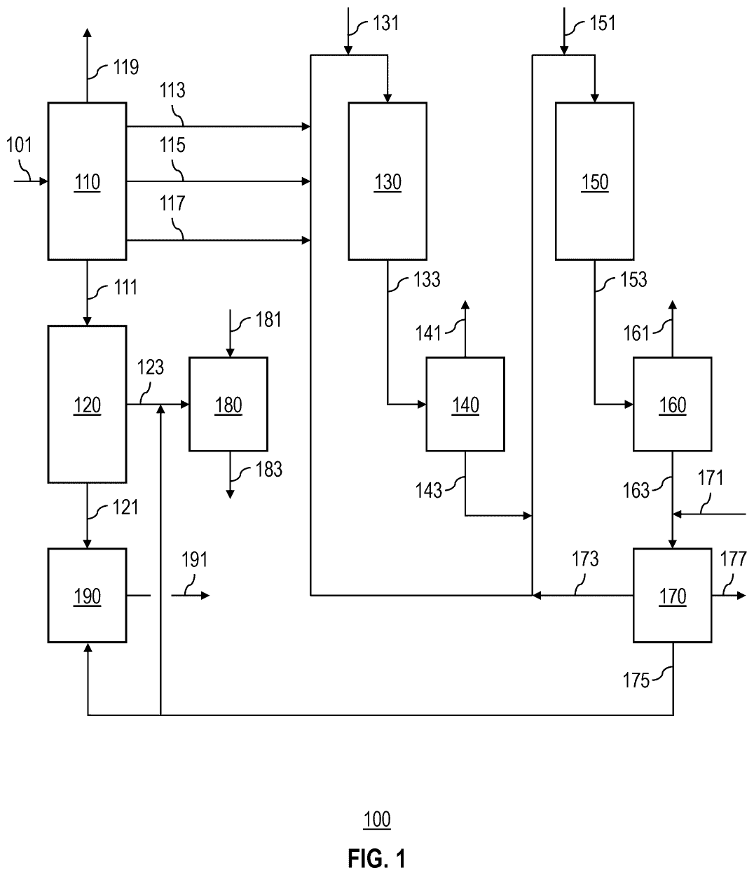

FIG. 1 depicts an example system 100 for refining crude oil obtained from subterranean formations. A crude oil stream 101 flows to the system 100 to be refined by the system 100. The crude oil stream 101 includes crude oil that has been produced from a subterranean formation. In some implementations, the crude oil stream 101 has been processed by a gas-oil separation plant (for example, that includes a desalter) to remove salt. In some implementations, the crude oil stream 101 is an export crude oil meeting export crude oil specifications, such as a salt content of less than about 10 pounds of salt per thousand barrels of crude oil (less than about 29 parts per million (ppm)), a basic sediment and water (BS&W) content of less than about 0.2 volume percent (vol. %), a hydrogen sulfide content of less than about 70 ppm by weight, and a maximum true vapor pressure (TVP) (per ASTM D 2879) of less than about 13 pounds per square inch absolute (psia) (less than about 90 kilopascals (kPa) absolute) at storage temperature. The BS&W is generally measured from a liquid sample of the crude oil stream 101. The BS&W includes water, sediment, and emulsion. The BS&W is typically measured as a volume percentage of the crude oil stream 101. The BS&W specification can be less than about 0.5 vol. % for heavy crude oil and less than about 0.2 vol. % for other crude oils.

The system 100 can include an atmospheric distillation unit (ADU) 110. The ADU 110 is configured to receive the crude oil stream 101. The ADU 110 can include an inlet configured to receive the crude oil stream 101. The ADU 110 can include an atmospheric distillation column (also referred to as an atmospheric column). The atmospheric distillation column can include equipment and components typical of distillation columns. For example, the atmospheric distillation column of the ADU 110 includes trays, a reboiler, a condenser, and pumps. The ADU 110 is configured to fractionate the crude oil stream 101. The ADU 110 separates the crude oil stream 101 into two or more process streams based on the differences in relative volatility of the components in the crude oil stream 101. The ADU 110 can, for example, separate an atmospheric residue stream 111 from the crude oil stream 101. The atmospheric residue stream 111 can include the heaviest components of the crude oil stream 101. In some implementations, the ADU 110 separates additional process streams from the crude oil stream 110. In some implementations, the ADU 110 separates a naphtha stream 113 from the crude oil stream 101. The naphtha stream 113 includes naphtha. The naphtha stream 113 can include light naphtha, heavy naphtha, or both. In some implementations, the ADU 110 separates a kerosene stream 115 from the crude oil stream 101. The kerosene stream 115 includes kerosene. The kerosene stream 115 can include light kerosene, heavy kerosene, or both. In some implementations, the ADU 110 separates a diesel stream 117 from the crude oil stream 101. The diesel stream 117 includes diesel. In some implementations, the ADU 110 separates a fuel gas 119 from the crude oil stream 101. The fuel gas 119 can include the lightest components of the crude oil stream 101. For example, the fuel gas 119 can include C1-C4 and hydrogen sulfide. The fuel gas 119 can, for example, flow to a fuel gas treatment unit for further separation and/or processing.

The system 100 can include a vacuum distillation unit (VDU) 120. The VDU 120 is configured to receive at least a portion of the atmospheric residue stream 111 from the ADU 110. The VDU 120 can include an inlet configured to receive the atmospheric residue stream 111. The VDU 120 can include a vacuum distillation column (also referred to as a vacuum column). The vacuum distillation column can include equipment and components typical of distillation columns. The VDU 120 is configured to fractionate the atmospheric residue stream 111. The VDU 120 separates the atmospheric residue stream 111 into two or more process streams based on the differences in relative volatility of the components in the atmospheric residue stream 111. The VDU 120 operates at a lower pressure in comparison to the ADU 110. For example, the ADU 110 operates at approximately atmospheric pressure, and the VDU 120 operates at a vacuum pressure (that is, less than atmospheric pressure). The VDU 120 can, for example, separate a vacuum residue stream 121 from the atmospheric residue stream 111. The vacuum residue stream 121 can include the heaviest components of the atmospheric residue stream 111. In some implementations, the VDU 120 separates additional process streams from the atmospheric residue stream 111. In some implementations, the VDU 120 separates a vacuum gas oil (VGO) stream 123 from the atmospheric residue stream 111. The vacuum gas oil stream 123 includes vacuum gas oil. The VGO stream 123 can include light vacuum gas oil, heavy vacuum gas oil, or both.

The system 100 can include a hydrotreating unit 130. The hydrotreating unit 130 is configured to receive at least a portion of the naphtha stream 113 from the ADU 110. The hydrotreating unit 130 can include an inlet configured to receive the naphtha stream 113. In some implementations, the hydrotreating unit 130 is configured to receive at least a portion of the kerosene stream 115 from the ADU 110. In some implementations, the hydrotreating unit 130 is configured to receive at least a portion of the diesel stream 117 from the ADU 110. In some implementations, the hydrotreating unit 130 is configured to receive at least a portion of the VGO stream 123 from the VDU 120. In some implementations, at least one of at least a portion of the kerosene stream 115, at least a portion of the diesel stream 117, or at least a portion of the VGO stream 123 mixes with at least the portion of the naphtha stream 113 entering the hydrotreating unit 130, and the mixture flows into the hydrotreating unit 130 via the inlet. In some implementations, at least a portion of the kerosene stream 115, at least a portion of the diesel stream 117, or at least a portion of the VGO stream 123 flows into the hydrotreating unit 130 separately from at least the portion of the naphtha stream 113, for example, via a different inlet of the hydrotreating unit 130. The hydrotreating unit 130 is configured to receive a hydrogen stream 131. The hydrogen stream 131 includes hydrogen. In some implementations, the hydrogen stream 131 mixes with at least the portion of the naphtha stream 113 entering the hydrotreating unit 130, and the mixture flows into the hydrotreating unit 130 via the inlet. In some implementations, the hydrogen stream 131 flows into the hydrotreating unit 130 separately from at least the portion of the naphtha stream 113, for example, via a different inlet of the hydrotreating unit 130 (for example, via a hydrogen injector).

The hydrotreating unit 130 includes a hydrotreating vessel. The hydrotreating unit 130 includes a hydrotreating catalyst disposed within the hydrotreating vessel. The hydrotreating catalyst accelerates the rate of reactions involving the removal of sulfur and nitrogen from carbon-containing compounds. The hydrotreating catalyst can include, for example, an alumina base impregnated with cobalt, molybdenum, nickel, or any combinations of these. The hydrotreating unit 130 can include equipment and components typical of distillation columns. For example, the hydrotreating unit 130 can include a heater, a heat exchanger, a hydrogen injector, a reactor (hydrotreating vessel), a separator, a stripper column, or any combinations of these. The hydrotreating unit 130 is configured to bring hydrogen stream 131 and the process stream(s) (for example, the naphtha stream 113, the kerosene stream 115, the diesel stream 117, the VGO stream 123, or any combinations of these) in contact with the hydrotreating catalyst. The hydrotreating catalyst accelerates the rate of hydrogenation reactions between sulfur-containing organic compounds and hydrogen, which results in hydrocarbons and hydrogen sulfide (for example, in a vapor state). In some cases, the hydrotreating catalyst can accelerate the rate of hydrogenation reactions between nitrogen-containing organic compounds and hydrogen, which results in hydrocarbons and ammonia (for example, in a vapor state). The hydrotreating unit 130 separates the hydrogen sulfide (and in some cases, ammonia) from the hydrocarbons to produce a hydrotreated effluent 133.

The system 100 can include a separation unit 140. The separation unit 140 is configured to receive at least a portion of the hydrotreated effluent 133 from the hydrotreating unit 130. The separation unit 140 can include an inlet configured to receive the hydrotreated effluent 133. The separation unit 140 is configured to separate the lighter, gaseous components from the hydrotreated effluent 133 to produce a light ends stream 141 and a hydrotreated distillate stream 143. The light ends stream 141 includes the lighter, vaporized components of the hydrotreated effluent 133. The hydrotreated distillate stream 143 includes the heavier, liquid components of the hydrotreated effluent 133. The separation unit 140 can, for example, include a heater and a flash drum. The heater can heat the hydrotreated effluent 133, which can facilitate flashing (vaporization) of the lighter components from the hydrotreated effluent 133. In some cases, the heater can be omitted. The flash drum can be shaped and sized to allow denser fluid (liquid) to gravity settle to the bottom of the flash drum, while the less dense fluid (vapor) is withdrawn from the top of the flash drum. The flash drum can be configured to discharge the light ends stream 141 at or near the top of the flash drum. The flash drum can be configured to discharge the hydrotreated distillate stream 143 at or near the bottom of the flash drum.

The system 100 can include a deep hydrogenation unit (DHU) 150. The DHU 150 is configured to receive at least a portion of the hydrotreated distillate stream 143 from the separation unit 140. The DHU 150 can include an inlet configured to receive the hydrotreated distillate stream 143. The DHU 150 is configured to receive a second hydrogen stream 151. The second hydrogen stream 151 includes hydrogen. The second hydrogen stream 151 can be a hydrogen stream separate from the hydrogen stream 131, or the second hydrogen stream 151 can branch from the hydrogen stream 131. In some implementations, the second hydrogen stream 151 mixes with at least the portion of the hydrotreated distillate stream 143 entering the DHU 150, and the mixture flows into the DHU 150 via the inlet. In some implementations, the second hydrogen stream 151 flows into the DHU 150 separately from at least the portion of the hydrotreated distillate stream 143, for example, via a different inlet of the DHU 150.

The DHU 150 operates under conditions effective for deep hydrogenation of middle distillates from source(s) within the system 100 for conversion of unsaturated hydrocarbons (such as aromatics) into saturated hydrocarbons (such as cycloalkanes and other non-aromatic compounds). The DHU 150 is configured to react at least the portion of the hydrotreated distillate stream 143 with the second hydrogen stream 151 to produce a deeply hydrogenated distillate stream 153.

The DHU 150 includes a hydrogenation catalyst that accelerates the rate of reactions between unsaturated hydrocarbons and hydrogen. The hydrogenation catalyst can include one or more active metal component(s) of metals or metal compounds (oxides or sulfides) selected from the Periodic Table of the Elements IUPAC Groups 7, 8, 9 and 10. In some implementations, the hydrogenation catalyst includes platinum (Pt), palladium (Pd), titanium (Ti), rhodium (Rh), rhenium (Re), iridum (Ir), ruthenium (Ru), nickel (Ni), or any combinations of these as the active metal component(s). In some implementations, the active metal component(s) of the hydrogenation catalyst includes a noble metal, such as at least one of Pt, Pd, Rh, Re, Ir, or Ru. The combinations of active metal components of the hydrogenation catalyst can be composed of different particles containing a single active metal species or particles containing multiple active species. Such noble metals can be provided in the range of from about 0.01 weight percent (wt. %) to about 5 wt. %, from about 0.01 wt. % to about 2 wt. %, from about 0.05 wt. % to about 5 wt. %, from about 0.05 wt. % to about 2 wt. %, from about 0.1 wt. % to about 5 wt. %, from about 0.1 wt. % to about 2 wt. %, from about 0.5 wt. % to about 5 wt. %, or from about 0.5 wt. % to about 2 wt. % (based on the mass of the metal(s) relative to the total mass of the hydrogenation catalyst). In some implementations, particles of the hydrogenation catalyst have a pore volume in the range of from about 0.15 cubic centimeters per gram (cc/g) to about 1.70 cc/gm, from about 0.15 cc/gm to about 1.50 cc/gm, from about 0.30 cc/gm to about 1.50 cc/gm, or from about 0.30 cc/gm to about 1.70 cc/gm. In some implementations, particles of the hydrogenation catalyst have a specific surface area in the range of from about 100 square meters per gram (m²/g) to about 400 m²/g, from about 100 m²/g to about 350 m²/g, from about 100 m²/g to about 300 m²/g, from about 150 m²/g to about 400 m²/g, from about 150 m²/g to about 350 m²/g, from about 150 m²/g to about 300 m²/g, from about 200 m²/g to about 400 m²/g, from about 200 m²/g to about 350 m²/g, or from about 200 m²/g to about 300 m²/g. In some implementations, particles of the hydrogenation catalyst have an average pore diameter of at least about 10 angstroms (Å), at least about 50 Å, at least about 100 Å, at least about 200 Å, at least about 500 Å, or at least about 1000 Å.

The active metal component(s) of the hydrogenation catalyst is/are typically deposited or otherwise incorporated on a support such as amorphous alumina, and in some implementations, non-acidic amorphous alumina. In some implementations, the support of the hydrogenation catalyst includes non-acidic amorphous alumina containing from about 0.1 wt. % to about 20 wt. %, from about 0.1 wt. % to about 15 wt. %, from about 0.1 wt. % to about 10 wt. %, from about 0.1 wt. % to about 5 wt. %, from about 0.5 wt. % to about 20 wt. %, from about 0.5 wt. % to about 15 wt. %, from about 0.5 wt. % to about 10 wt. %, from about 0.5 wt. % to about 5 wt. %, from about 1 wt. % to about 20 wt. %, from about 1 wt. % to about 15 wt. %, from about 1 wt. % to about 10 wt. %, from about 2.5 wt. % to about 20 wt. %, from about 2.5 wt. % to about 15 wt. %, or from about 2.5 wt. % to about 10 wt. % of zeolite (such as ultrastable Y (USY) zeolite). Non-acidic hydrogenation catalysts can be selected for the DHU 150 so as to favor hydrogenation reactions over hydrocracking reactions. Particularly effective hydrogenation catalysts for promoting hydrogenation reactions include, but are not limited to, noble metal active catalyst components on non-acidic supports, such as Pt, Pd, or both. In some implementations, a suitable hydrogenation catalyst includes a non-acidic support, such as alumina having Pt as the active metal component in an amount of from about 0.1 wt. % to about 0.5 wt. % based on the mass of the metal relative to the total mass of the dehydrogenation catalyst, with relatively small amounts of zeolite (such as USY zeolite), for instance, from about 0.1 wt. % to about 5 wt. %.

In some implementations, the hydrogenation catalyst (and/or the support of the hydrogenation catalyst) includes a modified USY zeolite support having at least one of titanium (Ti), zirconium (Zr), or hafnium (Hf) substituting the aluminum atoms constituting the framework of the zeolite. For example, the hydrogenation catalyst can include active metal component(s) carried on a support containing an ultra-stable Y-type zeolite, in which the USY zeolite is a framework-substituted zeolite (referred to as a framework-substituted zeolite) in which at least a portion of aluminum atoms constituting the zeolite framework is substituted with about 0.1 mass percent (mass %) to about 5 mass % zirconium atoms and about 0.1 mass % to about 5 mass % Ti ions, calculated on an oxide basis.

Hydrogenation catalysts using noble metal active catalyst components are effective at relatively lower temperatures. As will be appreciated by those having ordinary skill in the art, aromatic hydrogenation reactions are more favorable at lower temperatures, whereas high temperatures are required for cracking. The operating temperature suitable for cracking can be from about 30° C. to about 80° C. greater than the operating temperature suitable for hydrogenation with regards to the hydrogenation catalyst.

In some implementations, a hydrogen partial pressure within the DHU 150 is in a range of from about 2,000 kilopascals gauge (kPag) to about 10,000 kPag, from about 5,000 kPag to about 15,000 kPag, from about 2,000 kPag to about 8,500 kPag, from about 2,000 kPag to about 7,000 kPag, from about 3,000 kPag to about 10,000 kPag, from about 3,000 kPag to about 8,500 kPag, from about 3,000 kPag to about 4,000 kPag, from about 4,000 kPag to about 10,000 kPag, from about 4,000 kPag to about 8,500 kPag, or from about 4,000 kPag to about 7,000 kPag. In some implementations, an operating temperature (hydrogenation temperature) within the DHU 150 is in a range of from about 250° C. to about 400° C., from about 250° C. to about 320° C., from about 250° C. to about 315° C., from about 250° C. to about 310° C., from about 280° C. to about 320° C., from about 280° C. to about 315° C., from about 280° C. to about 310° C., from about 285° C. to about 320° C., from about 285° C. to about 315° C., from about 285° C. to about 310° C., from about 290° C. to about 320° C., from about 290° C. to about 315° C., or from about 290° C. to about 310° C. In some implementations, a liquid hourly space velocity on a fresh feed basis relative to the hydrogenation catalyst of the portion of the hydrotreated distillate stream 143 within the DHU 150 is in a range of from about 0.1 per hour (h⁻¹) to about 5.0 h⁻¹, from about 0.1 h⁻¹ to about 3.0 h⁻¹, from about 0.1 h⁻¹ to about 2.0 h⁻¹, from about 0.5 h⁻¹ to about 5.0 h⁻¹, from about 0.5 h⁻¹ to about 3.0 h⁻¹, from about 0.5 h⁻¹ to about 2.0 h⁻¹, from about 1.0 h⁻¹ to about 5.0 h⁻¹, from about 1.0 h⁻¹ to about 5.0 h⁻¹, or from about 1.0 h⁻¹ to about 2.0 h⁻¹. In some implementations, a hydrogen-to-oil feed ratio within the DHU 150 is in a range of from about 100 standard liters per liter (StL/L) to about 1,500 StL/L, from about 500 StL/L to about 3,000 StL/L, from about 500 StL/L to about 2,000 StL/L, from about 500 StL/L to about 1,500 StL/L, from about 1,000 StL/L to about 3,000 StL/L, from about 1,000 StL/L to about 2,000 StL/L, or from about 1,000 StL/L to about 1,500 StL/L.

The selection of catalysts, conditions and the like for deep hydrogenation are dependent on the feed, the aromatic content, and the types of aromatics in the feed. The deeply hydrogenated distillate stream 153 contains the hydrogenated middle distillate range compounds and lighter fractions. In some implementations, the selection of the hydrogenation catalyst and hydrogenation conditions in the DHU 150 are suitable to reduce aromatic content in a middle distillate range feed (for example, the hydrotreated distillate stream 143) in a range of from about 10 wt. % to about 40 wt. % or greater, to produce a hydrogenated distillate range intermediate product (for example, the deeply hydrogenated distillate stream 153) having an aromatic content of less than about 5 wt. %, less than about 2.5 wt. %, less than about 1 wt. %, or less than about 0.5 wt. %. In some implementations, the deeply hydrogenated distillate stream 153 includes less than about 5 wt. %, less than about 2.5 wt. %, less than about 1 wt. %, or less than about 0.5 wt. % of aromatics. In some implementations, the deeply hydrogenated distillate stream 153 has an aromatics content in a range of from about 0.5 wt. % to about 5 wt. %, from about 1 wt. % to about 5 wt. %, from about 0.5 wt. % to about 2.5 wt. %, from about 1 wt. % to about 2.5 wt. %, or from about 0.5 wt. % to about 1 wt. %. For example, the deeply hydrogenated distillate stream 153 exiting the DHU 150 has an aromatics content of less than about 1 wt. %. In some implementations, the deeply hydrogenated distillate stream 153 is substantially free of aromatics. In some implementations, the hydrotreated distillate stream 143 entering the DHU 150 has an aromatics content of at least about 10 wt. %. For example, the hydrotreated distillate stream 143 entering the DHU 150 has an aromatics content in a range of from about 10 wt. % to 100 wt. %. In some implementations, the hydrotreated distillate stream 143 entering the DHU 150 has an aromatics content of at least about 10 wt. %, and the deeply hydrogenated distillate stream 153 exiting the DHU 150 is substantially free of aromatics.

The system 100 can include a gas-liquid separation unit 160. The gas-liquid separation unit 160 can be substantially similar to the separation unit 140. The gas-liquid separation unit 160 is configured to receive at least a portion of the deeply hydrogenated distillate stream 153 from the DHU 150. The gas-liquid separation unit 160 can include an inlet configured to receive the deeply hydrogenated distillate stream 153. The gas-liquid separation unit 160 is configured to separate the lighter, gaseous components from the deeply hydrogenated distillate stream 153 to produce a second light ends stream 161 and a deeply hydrogenated distillate liquid stream 163. The second light ends stream 161 includes the lighter, vaporized components of the deeply hydrogenated distillate stream 153. The deeply hydrogenated distillate liquid stream 163 includes the heavier, liquid components of the deeply hydrogenated distillate stream 153. The gas-liquid separation unit 160 can, for example, include a heater and a flash drum. The heater can heat the deeply hydrogenated distillate stream 153, which can facilitate flashing (vaporization) of the lighter components from the deeply hydrogenated distillate stream 153. In some cases, the heater can be omitted. The flash drum can be shaped and sized to allow denser fluid (liquid) to gravity settle to the bottom of the flash drum, while the less dense fluid (vapor) is withdrawn from the top of the flash drum. The flash drum can be configured to discharge the second light ends stream 161 at or near the top of the flash drum. The flash drum can be configured to discharge the deeply hydrogenated distillate liquid stream 163 at or near the bottom of the flash drum.

The system 100 can include a steam cracking unit 170. The steam cracking unit 170 is configured to receive at least a portion of the deeply hydrogenated distillate liquid stream 163 from the gas-liquid separation unit 160. The steam cracking unit 170 can include an inlet configured to receive the deeply hydrogenated distillate liquid stream 163. The steam cracking unit 170 is configured to receive a steam stream 171. The steam stream 171 includes steam. In some implementations, the steam stream 171 mixes with at least the portion of the deeply hydrogenated distillate liquid stream 163 entering the steam cracking unit 170, and the mixture flows into the steam cracking unit 170 via the inlet. In some implementations, the steam stream 171 flows into the steam cracking unit 170 separately from at least the portion of the deeply hydrogenated distillate liquid stream 163, for example, via a different inlet of the steam cracking unit 170. The steam cracking unit 170 is configured to break carbon-carbon bonds of the deeply hydrogenated distillate liquid stream 163 in the presence of steam (steam stream 171) to produce a pyrolysis gasoline stream 173, a pyrolysis oil stream 175, and a mixed gas product stream 177. The pyrolysis gasoline stream 173 includes pyrolysis gasoline. The pyrolysis oil stream 175 includes pyrolysis oil. The pyrolysis oil stream 175 can include light pyrolysis oil, heavy pyrolysis oil, or both. The mixed gas product stream 177 includes olefins, and in particular, light olefins. The pyrolysis gasoline stream 173, the pyrolysis oil stream 175, or both can be recycled within the system 100. For example, at least a portion of the pyrolysis gasoline stream 173 is recycled to the hydrotreating unit 130. For example, at least a portion of the pyrolysis gasoline stream 173 is recycled to the hydrogenation unit 150. For example, at least a portion of the pyrolysis oil stream 175 is recycled to the hydrocracking unit 180. For example, at least a portion of the pyrolysis oil stream 175 is recycled to the residue upgrading unit 190. Recycling all of the pyrolysis gas stream 173 and the pyrolysis oil stream 175 produced by the steam cracker 170 to other units within the system 100 (such as the hydrotreating unit 130, the hydrogenation unit 150, the hydrocracking unit 180, the residue upgrading unit 190, or any combinations of these) can allow for bottomless operation of the steam cracking unit 170 and increased yield of light olefins.

The steam cracking unit 170 can include a convection section and a pyrolysis section. The steam cracking unit 170 operates under parameters effective to crack the feed into desired products, such as ethylene, propylene, butadiene, and mixed butenes. Pyrolysis gasoline and pyrolysis oil may also be recovered. In some implementations, the steam cracking unit 170 is operated at conditions effective to produce an effluent having a propylene-to-ethylene weight ratio of from about 0.3 to about 0.8, from about 0.3 to about 0.6, from about 0.4 to about 0.8, or from about 0.4 to about 0.6. The steam cracking unit 170 generally includes one or more trains of furnaces. For example, a typical arrangement of the steam cracking unit 170 includes reactors that can operate based on well-known steam pyrolysis methods, such as charging the thermal cracking feed to a convection section in the presence of steam to raise the temperature of the feedstock, and passing the heated feed to the pyrolysis reactor containing furnace tubes for cracking. In the convection section, the mixture is heated to a predetermined temperature, for example, using one or more waste heat streams or other suitable heating arrangement(s).

In some implementations, steam cracking in the steam cracking unit 170 is carried out at a steam cracking temperature in the convection section in a range of from about 300° C. to about 450° C. or from about 300° C. to about 400° C. In some implementations, steam cracking in the steam cracking unit 170 is carried out at a steam cracking pressure in the convection section in a range of from about 720 kPag to about 970 kPag, from about 720 kPag to about 850 kPag, from about 720 kPag to about 770 kPag, from about 770 kPag to about 850 kPag, from about 770 kPag to about 970 kPag, or from about 850 kPag to about 970 kPag. In some implementations, steam cracking in the steam cracking unit 170 is carried out at a pyrolysis temperature in the pyrolysis section in the range of from about 700° C. to about 850° C., from about 700° C. to about 800° C., from about 700° C. to about 820° C., from about 750° C. to about 850° C., from about 750° C. to about 800° C., or from about 750° C. to about 820° C. In some implementations, steam cracking in the steam cracking unit 170 is carried out at a pyrolysis pressure in the pyrolysis section in a range of from about 90 kPag to about 120 kPag, from about 90 kPag to about 140 kPag, from about 90 kPag to about 160 kPag, from about 120 kPag to about 140 kPag, from about 120 kPag to about 160 kPag, or from about 140 kPag to about 160 kPag. In some implementations, steam cracking in the steam cracking unit 170 is carried out at a steam-to-hydrocarbon ratio in the convection section in the range of from about 0.75:1 to about 2:1, from about 0.75:1 to about 1.5:1, from about 0.85:1 to about 2:1, from about 0.9:1 to about 1.5:1, from about 0.9:1 to about 2:1, from about 1:1 to about 2:1, or from about 1:1 to about 1.5:1. In some implementations, steam cracking in the steam cracking unit 170 is carried out at a residence time in the pyrolysis section in the range of from about 0.02 seconds(s) to about 1 s, from about 0.02 s to about 0.08 s, from about 0.02 s to about 0.5 s, from about 0.1 s to about 1 s, from about 0.1 s to about 0.5 s, from about 0.2 s to about 0.5 s, from about 0.2 s to about 1 s, or from about 0.5 s to about 1 s.

The system 100 can include a hydrocracking unit 180. The hydrocracking unit 180 is configured to receive at least a portion of the VGO stream 123 from the VDU 120. The hydrocracking unit 180 can include an inlet configured to receive the VGO stream 123. The hydrocracking unit 180 is configured to receive a third hydrogen stream 181. The third hydrogen stream 181 includes hydrogen. The third hydrogen stream 181 can be a hydrogen stream separate from the hydrogen stream 131 and the second hydrogen stream 151, or the third hydrogen stream 181 can branch from the hydrogen stream 131 or the second hydrogen stream 151. In some implementations, the hydrogen stream 181 mixes with at least the portion of the VGO stream 123 entering the hydrocracking unit 180, and the mixture flows into the hydrocracking unit 180 via the inlet. In some implementations, the hydrogen stream 181 flows into the hydrocracking unit 180 separately from at least the portion of the VGO stream 123, for example, via a different inlet of the steam cracking unit 170. The hydrocracking unit 180 is configured to hydrogenate and break carbon-carbon bonds of the VGO stream 123 using hydrogen (third hydrogen stream 181) to produce a cracked product stream 183.

In some implementations, the hydrocracking unit 180 is configured to receive at least a portion of the pyrolysis gasoline stream 173 from the steam cracking unit 170. In some implementations, the hydrocracking unit 180 is configured to receive at least a portion of the pyrolysis oil stream 175 from the steam cracking unit 170. In some implementations, at least one of at least a portion of the pyrolysis gasoline stream 173 or at least a portion of the pyrolysis oil stream 175 mixes with at least the portion of the VGO stream 123 entering the hydrocracking unit 180, and the mixture flows into the hydrocracking unit 180 via the inlet. In some implementations, at least a portion of the pyrolysis gasoline stream 173 and/or at least a portion of the pyrolysis oil stream 175 flows into the hydrocracking unit 180 separately from at least the portion of the VGO stream 123, for example, via a different inlet of the hydrocracking unit 180. By recycling the pyrolysis gasoline stream 173 and/or the pyrolysis oil stream 175 from the steam cracking unit 170 to the hydrocracking unit 180, the steam cracking unit 170 can reduce and/or eliminate its liquid bottoms output.

The hydrocracking unit 180 can include a hydrocracking reactor and a hydrocracking catalyst disposed within the hydrocracking reactor. In some implementations, the hydrocracking reactor of the hydrocracking unit 180 is an ebullated bed reactor. In such implementations, the hydrocracking catalyst is in an ebullated (suspended) state with random movement throughout the hydrocracking reactor. A recirculating pump can expand the catalytic bed and can maintain the hydrocracking catalyst in suspension within the hydrocracking reactor. The free movement of the hydrocracking catalyst (by nature of being ebullated) can permit on-line catalyst replacement of a small portion of the bed to produce a high net bed activity that remains relatively constant over time. In an ebullated bed reactor, highly contaminated feeds can be treated due to the continuous replacement of hydrocracking catalyst. In an ebullated bed reactor, catalyst withdrawal and replacement can be carried out to maintain catalyst activity within the reactor. This can also facilitate maintaining the operating temperature of the ebullated bed reactor at a constant, desired temperature throughout its operation.

In some implementations, the hydrocracking unit 180 operates at a hydrocracking temperature in a range of from about 370° C. to about 450° C., from about 370° C. to about 440° C., from about 370° C. to about 430° C., from about 380° C. to about 450° C., from about 380° C. to about 440° C., from about 380° C. to about 430° C., from about 390° C. to about 450° C., from about 390° C. to about 440° C., or from about 390° C. to about 430° C. In some implementations, the hydrocracking unit 180 operates at a hydrogen partial pressure in a range of from about 8,000 kPag to about 25,000 kPag, from about 8,000 kPag to about 20,000 kPag, from about 8,000 kPag to about 15,000 kPag, from about 9,000 kPag to about 25,000 kPag, from about 9,000 kPag to about 20,000 kPag, from about 9,000 kPag to about 15,000 kPag, from about 10,000 kPag to about 25,000 kPag, from about 10,000 kPag to about 20,000 kPag, or from about 10,000 kPag to about 15,000 kPag. In some implementations, the hydrocracking unit 180 operates at a hydrogen gas feed rate in relation to the liquid hydrocarbon feed rate in a range of from about 1,000 StL/L to about 3,500 StL/L, from about 1,000 StL/L to about 3,000 StL/L, from about 1,000 StL/L to about 2,500 StL/L, from about 1,500 StL/L to about 3,500 StL/L, from about 1,500 StL/L to about 3,000 StL/L, from about 1,500 StL/L to about 2,500 StL/L, from about 2,000 StL/L to about 3,500 StL/L, from about 2,000 StL/L to about 3,000 StL/L, or from about 2,000 StL/L to about 2,500 StL/L. In some implementations, the hydrocracking unit 180 operates at a liquid hourly space velocity on a fresh feed basis relative to the hydrotreating catalyst in a range of from about 0.1 h⁻¹ to about 4.0 h⁻¹, from about 0.1 h⁻¹ to about 2.0 h⁻¹, from about 0.1 h⁻¹ to about 1.5 h⁻¹, from about 0.1 h⁻¹ to about 1.0 h⁻¹, from about 0.2 h⁻¹ to about 4.0 h⁻¹, from about 0.2 h⁻¹ to about 2.0 h⁻¹, from about 0.2 h⁻¹ to about 1.5 h⁻¹, from about 0.2 h⁻¹ to about 1.0 h⁻¹, from about 0.5 h⁻¹ to about 4.0 h⁻¹, from about 0.5 h⁻¹ to about 2.0 h⁻¹, from about 0.5 h⁻¹ to about 1.5 h⁻¹, or from about 0.5 h⁻¹ to about 2.0 h⁻¹. In some implementations, the hydrocracking unit 180 operates at an annualized relative catalyst consumption (RCC) rate in a range of from about 1.0 to about 3.0, from about 1.0 to about 2.2, from about 1.0 to about 2.0, from about 1.0 to about 1.8, from about 1.0 to about 1.4, from about 1.2 to about 3.0, from about 1.2 to about 2.2, from about 1.2 to about 1.4, from about 1.4 to about 3.0, from about 1.4 to about 2.2, from about 1.4 to about 1.8, from about 1.4 to about 1.6, from about 1.6 to about 1.8, from about 1.8 to about 2.0, or from about 2.0 to about 2.2.

Suitable hydrocracking catalysts for use in the hydrocracking unit 180 can include those exhibiting hydrotreating functionality. Such hydrocracking catalysts can, for example, include an effective amount, such as from about 5 wt. % to about 40 wt. % (based on the weight of the hydrocracking catalyst) of one or more active metal component(s) of metals or metal compounds (oxides or sulfides) selected from the Periodic Table of the Elements IUPAC Groups 6, 7, 8, 9 and 10. In some implementations, the hydrocracking catalyst includes at least one of cobalt (Co), Ni, or molybdenum (Mo) as the active metal component(s). The active metal component(s) of the hydrocracking catalyst is/are typically deposited or otherwise incorporated on a support, such as amorphous alumina, amorphous silica alumina, zeolites, or any combinations of these. One or more series of hydrocracking reactors can be included in the hydrocracking unit 180, with different or the same hydrocracking catalysts in the various reactors of each series.

In some implementations, the system 100 can include a fluid catalytic cracking (FCC) unit in addition to or alternative to the hydrocracking unit 180 to produce the cracked product stream 183. An FCC unit has a similar function as the hydrocracking unit 180 in that the FCC unit converts high-boiling point, high-molecular weight hydrocarbon fractions of petroleum (such as HGO and residues) into gasoline, alkene gases, and other petroleum products. An FCC unit heats the feedstock and brings the feedstock in contact with a powdered catalyst to break the long-chain molecules of the high-boiling point hydrocarbon liquids into short-chain molecules, which can be collected as vapor.

The system 100 can include a residue upgrading unit 190. The residue upgrading unit 190 is configured to receive at least a portion of the vacuum residue stream 121 from the VDU 120. The residue upgrading unit 190 can include an inlet configured to receive the vacuum residue stream 121. In some implementations, the residue upgrading unit 190 is configured to receive at least a portion of the pyrolysis oil 175 from the steam cracking unit 170. In some implementations, at least the portion of the pyrolysis oil stream 175 mixes with at least the portion of the vacuum residue stream 121 entering the residue upgrading unit 190, and the mixture flows into the residue upgrading unit 190 via the inlet. In some implementations, at least the portion of the pyrolysis oil stream 175 flows into the residue upgrading unit 190 separately from at least the portion of the vacuum residue stream 121, for example, via a different inlet of the residue upgrading unit 190. By recycling the pyrolysis oil stream 175 from the steam cracking unit 170 to the residue upgrading unit 190, the steam cracking unit 170 can reduce and/or eliminate its liquid bottoms output. The residue upgrading unit 190 is configured to convert the feedstock (at least the portion of the vacuum residue stream 121 or both the vacuum residue stream 121 and the pyrolysis oil stream 175), for example, to increase an octane number of the feedstock to produce a middle distillate stream 191. The residue upgrading unit 190 can include, for example, residue hydroprocessing. For example, the residue upgrading unit 190 includes a residue hydrotreater, a residue hydrocracker, or both. The middle distillate stream 191 can be flowed to the hydrocracking unit 180, the hydrotreating unit 130, the hydrogenation unit 150, or any combinations of these for further processing. The hydrogenation unit 150 can deeply hydrogenate the middle distillate stream 191 to saturate hydrocarbons of the middle distillate stream 191.

In each of the configurations described with respect to the system 100 and its subsystems (such as the ADU 110, the VDU 120, the hydrotreating unit 130, the separation unit 140, the DHU 150, the gas-liquid separation unit 160, the steam cracking unit 170, the hydrocracking unit 180, and the residue upgrading unit 190), process streams (also referred to as “streams”) are flowed within each subsystem of the system 100 and between subsystems of the system 100. The process streams can be flowed using one or more flow control systems implemented throughout the system 100 (and/or its subsystems). A flow control system can include one or more flow pumps to pump the process streams (such as the crude oil stream 101), one or more compressors to pressurize the process streams, one or more flow pipes through which the process streams are flowed, and one or more valves to regulate the flow of streams through the pipes.

In some implementations, a flow control system can be operated manually. For example, an operator can set a flow rate for each pump and/or compressor by changing the position of a valve (open, partially open, or closed) to regulate the flow of the process streams through the pipes in the flow control system. Once the operator has set the flow rates and the valve positions for all flow control systems distributed across the system 100 (and/or its subsystems), the flow control system can flow the streams within a unit or between units under constant flow conditions, for example, constant volumetric or mass flow rates. To change the flow conditions, the operator can manually operate the flow control system, for example, by changing the valve position.

In some implementations, a flow control system can be operated automatically. For example, the flow control system can be connected to a computer system to operate the flow control system. The computer system can include a computer-readable medium storing instructions (such as flow control instructions) executable by one or more processors to perform operations (such as flow control operations). For example, an operator can set the flow rates by setting the valve positions for all flow control systems distributed across the system 100 (and/or its subsystems) using the computer system. In such implementations, the operator can manually change the flow conditions by providing inputs through the computer system. In such implementations, the computer system can automatically (that is, without manual intervention) control one or more of the flow control systems, for example, using feedback systems implemented in one or more units and connected to the computer system. For example, a sensor (such as a pressure sensor or temperature sensor) can be connected to a pipe through which a process stream flows. The sensor can monitor and provide a flow conditions (such as a pressure or temperature) of the process stream to the computer system. In response to the flow condition deviating from a set point (such as a target pressure value or target temperature value) or exceeding a threshold (such as a threshold pressure value or threshold temperature value), the computer system can automatically perform operations. For example, if the pressure or temperature in the pipe exceeds the threshold pressure value or the threshold temperature value, respectively, the computer system can provide a signal to open a valve to relieve pressure or a signal to shut down process stream flow.

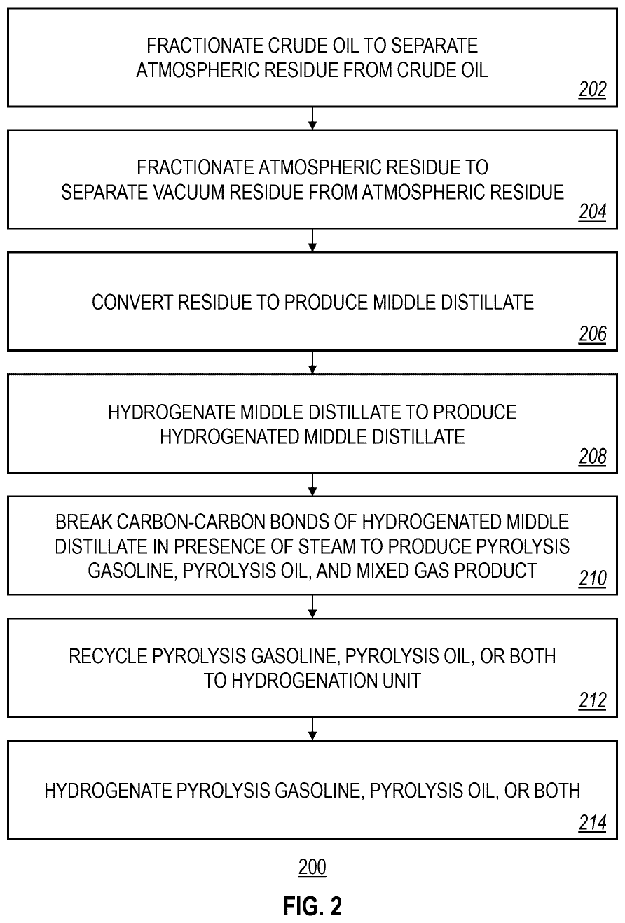

FIG. 2 is a flow chart of an example method 200 for refining crude oil obtained from subterranean formations. The system 100 can, for example, implement the method 200. At block 202, an atmospheric column (such as the ADU 110) fractionates a crude oil stream (such as the crude oil stream 101) obtained from a subterranean formation to separate at least an atmospheric residue stream (such as the atmospheric residue stream 111) from the crude oil stream 101. At block 204, a vacuum column (such as the VDU 120) fractionates at least a portion of the atmospheric residue stream 111 to separate at least a vacuum residue stream (such as the vacuum residue stream 121) from at least the portion of the atmospheric residue stream 111. At block 206, a residue upgrading unit (such as the residue upgrading unit 190) converts a feedstock that includes at least one of the vacuum residue stream 121 or a second portion of the atmospheric residue stream 111 to produce at least a middle distillate stream (such as the middle distillate stream 191). At block 208, a hydrogenation unit (such as the hydrogenation unit 150) that includes a hydrogenation catalyst hydrogenates at least a portion of the middle distillate stream 191 to produce a hydrogenated middle distillate stream (such as the hydrogenated distillate stream 153). At block 210, carbon-carbon bonds of at least a portion of the hydrogenated distillate stream 153 is broken in the presence of steam (such as the steam stream 171) to produce a pyrolysis gasoline (such as the pyrolysis gasoline stream 173), a pyrolysis oil (such as the pyrolysis oil stream 175), and a mixed gas product (such as the mixed gas product stream 177). At block 212, at least a portion of the pyrolysis gasoline stream 173, at least a portion of the pyrolysis oil stream 175, or both are recycled to the hydrogenation unit 150. At block 214, the hydrogenation unit 150 hydrogenates at least the portion of the pyrolysis gasoline stream 173, at least the portion of the pyrolysis oil stream 175, or both.

### Embodiments

In an example implementation (or aspect), a method comprises: fractionating, by an atmospheric column, a crude oil stream obtained from a subterranean formation to separate at least an atmospheric residue stream from the crude oil stream; fractionating, by a vacuum column, at least a portion of the atmospheric residue stream to separate at least a vacuum residue stream from at least the portion of the atmospheric residue stream; converting, by a residue upgrading unit, a feedstock comprising at least one of the vacuum residue stream or a second portion of the atmospheric residue stream to produce at least a middle distillate stream; hydrogenating, by a hydrogenation unit comprising a hydrogenation catalyst, at least a portion of the middle distillate stream to produce a hydrogenated middle distillate stream; breaking carbon-carbon bonds of at least a portion of the hydrogenated middle distillate stream in the presence of steam to produce a pyrolysis gasoline, a pyrolysis oil, and a mixed gas product comprising light olefins; recycling at least of a portion of the pyrolysis gasoline, at least of a portion of the pyrolysis oil, or both to the hydrogenation unit; and hydrogenating, by the hydrogenation unit, at least the portion of the pyrolysis gasoline, at least the portion of the pyrolysis oil, or both.

In an example implementation (or aspect) combinable with any other example implementation (or aspect), the method comprises subjecting the portion of the middle distillate stream produced by the residue upgrading unit to hydroprocessing prior to hydrogenating the portion of the middle distillate stream.

In an example implementation (or aspect) combinable with any other example implementation (or aspect), the portion of the middle distillate stream that is hydrogenated by the hydrogenation unit has an aromatics content in a range of from about 10 weight percent (wt. %) to 100 wt. %, and the hydrogenated middle distillate stream is substantially free of aromatics.

In an example implementation (or aspect) combinable with any other example implementation (or aspect), the hydrogenation catalyst comprises an active metal comprising at least one of platinum (Pt), palladium (Pd), or rhenium (Re), wherein the hydrogenation catalyst comprises a support comprising non-acidic amorphous alumina and a zeolite having at least one of titanium (Ti), zirconium (Zr), or hafnium (Hf) substituting aluminum atoms constituting a framework of the zeolite.

In an example implementation (or aspect) combinable with any other example implementation (or aspect), fractionating at least the portion of the atmospheric residue stream by the vacuum column produces at least a vacuum gas oil stream.

In an example implementation (or aspect) combinable with any other example implementation (or aspect), the method comprises subjecting at least a portion of the vacuum gas oil stream to hydroprocessing or fluid catalytic cracking to produce a second middle distillate stream.

In an example implementation (or aspect) combinable with any other example implementation (or aspect), the method comprises hydrogenating, by the hydrogenation unit, at least a portion of the second middle distillate stream.

In an example implementation (or aspect) combinable with any other example implementation (or aspect), the portion of the middle distillate stream is hydrogenated by the hydrogenation unit at a hydrogen partial pressure in a range of from about 5,000 kilopascals gauge (kPag) to about 15,000 kPag.

In an example implementation (or aspect) combinable with any other example implementation (or aspect), the portion of the middle distillate stream is hydrogenated by the hydrogenation unit at a hydrogenation temperature in a range of from about 250 degrees Celsius (C) to about 400° C.

In an example implementation (or aspect) combinable with any other example implementation (or aspect), the portion of the middle distillate stream is hydrogenated by the hydrogenation unit at a liquid hourly space velocity on a fresh feed basis relative to the hydrogenation catalyst in a range of from about 0.1 per hour (h⁻¹) to about 5.0 h⁻¹.

In an example implementation (or aspect) combinable with any other example implementation (or aspect), the portion of the middle distillate stream is hydrogenated by the hydrogenation unit at a hydrogen-to-oil feed ratio in a range of from about 100 standard liters per liter (StL/L) to about 1,500 StL/L.

In an example implementation (or aspect) combinable with any other example implementation (or aspect), the method comprises, prior to hydrogenating the portion of the middle distillate stream, mixing the portion of the middle distillate stream with an excess of hydrogen to produce a mixture of hydrogen-enriched middle distillates and undissolved hydrogen.

In an example implementation (or aspect) combinable with any other example implementation (or aspect), the method comprises, prior to hydrogenating the portion of the middle distillate stream, removing at least a portion of the undissolved hydrogen from the mixture to produce a hydrogen-enriched middle distillate stream, wherein hydrogenating at least the portion of the middle distillate stream comprises hydrogenating at least a portion of the hydrogen-enriched middle distillate stream.

In an example implementation (or aspect) combinable with any other example implementation (or aspect), the method comprises breaking carbon-carbon bonds of at least a second portion of the middle distillate stream in the presence of steam to produce additional light olefins.

In an example implementation (or aspect) combinable with any other example implementation (or aspect), the method comprises subjecting at least one of the portion of the pyrolysis gasoline or the portion of the pyrolysis oil to hydroprocessing prior to recycling at least one of the portion of the pyrolysis gasoline or the portion of the pyrolysis oil to the hydrogenation unit.

In an example implementation (or aspect) combinable with any other example implementation (or aspect), the method comprises recycling a second portion of the pyrolysis oil to the residue upgrading unit.

In an example implementation (or aspect), a system for refining crude oil obtained from a subterranean formation, the system comprising: an atmospheric column configured to receive the crude oil and separate at least an atmospheric residue stream from the crude oil; a vacuum column configured to receive at least a portion of the atmospheric residue stream from the atmospheric column and separate at least a vacuum residue stream from at least the portion of the atmospheric residue stream; a residue upgrading unit configured to receive at least one of the vacuum residue stream or a second portion of the atmospheric residue stream as a feedstock, wherein the residue upgrading unit is configured to convert at least a portion of the feedstock to produce at least a middle distillate stream; a hydrogenation unit comprising a hydrogenation catalyst comprising an active metal comprising at least one of platinum (Pt), palladium (Pd), or rhenium (Re), wherein the hydrogenation catalyst comprising a support comprising non-acidic amorphous alumina and a zeolite having at least one of titanium (Ti), zirconium (Zr), or hafnium (Hf) substituting aluminum atoms constituting a framework of the zeolite, wherein the hydrogenation unit is configured to receive at least a portion of the middle distillate stream from the residue upgrading unit, wherein the hydrogenation unit is configured to hydrogenate at least the portion of the middle distillate stream in the presence of the hydrogenation catalyst to produce a hydrogenated middle distillate stream; and a steam cracking unit configured to receive steam and at least a portion of the hydrogenated middle distillate stream, wherein the steam cracking unit is configured to break carbon-carbon bonds of the portion of the hydrogenated middle distillate stream in the presence of steam to produce a pyrolysis gasoline, a pyrolysis oil, and a mixed gas product comprising light olefins, wherein the hydrogenation unit is configured to receive and hydrogenate at least one of a portion of the pyrolysis gasoline or a portion of the pyrolysis oil from the steam cracking unit.

In an example implementation (or aspect) combinable with any other example implementation (or aspect), the system comprises a hydroprocessing unit comprising a hydrotreater and a hydrocracker, wherein the hydroprocessing unit is configured to receive and react at least the portion of the middle distillate stream produced by the residue upgrading unit with hydrogen to break carbon-carbon bonds of and remove sulfur-containing contaminants from the portion of the middle distillate stream upstream of the hydrogenation unit.

In an example implementation (or aspect) combinable with any other example implementation (or aspect), the vacuum column is configured to at least a vacuum gas oil stream from the portion of the atmospheric residue stream, wherein the hydroprocessing unit is configured to receive and react at least a portion of the vacuum gas oil with hydrogen to break carbon-carbon bonds of and remove sulfur-containing contaminants from the portion of the vacuum gas oil.

In an example implementation (or aspect) combinable with any other example implementation (or aspect), the portion of the middle distillate stream that is hydrogenated by the hydrogenation unit has an aromatics content in a range of from about 10 weight percent (wt. %) to 100 wt. %, and the hydrogenated middle distillate stream is substantially free of aromatics.

In an example implementation (or aspect) combinable with any other example implementation (or aspect), the portion of the middle distillate stream that is hydrogenated by the hydrogenation unit comprises at least about 10 weight percent (wt. %) aromatics, and the hydrogenated middle distillate stream comprises less than about 1 wt. % aromatics.

In an example implementation (or aspect) combinable with any other example implementation (or aspect), the system comprises the middle distillate stream.

In an example implementation (or aspect) combinable with any other example implementation (or aspect), a hydrogen partial pressure within the hydrogenation unit is in a range of from about 5,000 kilopascals gauge (kPag) to about 15,000 kPag.

In an example implementation (or aspect) combinable with any other example implementation (or aspect), a hydrogenation temperature within the hydrogenation unit is in a range of from about 250 degrees Celsius (° C.) to about 400° C.

In an example implementation (or aspect) combinable with any other example implementation (or aspect), a liquid hourly space velocity on a fresh feed basis relative to the hydrogenation catalyst of the portion of the middle distillate stream within the hydrogenation unit is in a range of from about 0.1 per hour (h⁻¹) to about 5.0 h⁻¹.

In an example implementation (or aspect) combinable with any other example implementation (or aspect), a hydrogen-to-oil feed ratio within the hydrogenation unit is in a range of from about 100 standard liters per liter (StL/L) to about 1,500 StL/L.

In an example implementation (or aspect) combinable with any other example implementation (or aspect), the steam cracking unit is configured to receive and break carbon-carbon bonds of at least a second portion of the middle distillate stream in the presence of steam to produce additional light olefins.

In an example implementation (or aspect) combinable with any other example implementation (or aspect), the hydroprocessing unit is configured to receive and react at least one of the portion of the pyrolysis gasoline or the portion of the pyrolysis oil produced by the steam cracking unit with hydrogen to break carbon-carbon bonds of and remove sulfur-containing contaminants from at least one of the portion of the pyrolysis gasoline or the portion of the pyrolysis oil, upstream of the hydrogenation unit.

In an example implementation (or aspect) combinable with any other example implementation (or aspect), the residue upgrading unit is configured to receive at least a second portion of the pyrolysis oil from the steam cracking unit.

In an example implementation (or aspect), a system comprises: a vacuum distillation tower configured to receive an atmospheric residue stream from an atmospheric distillation tower, wherein the vacuum distillation tower is configured to fractionate the atmospheric residue stream to produce at least a vacuum residue stream; a residue upgrading unit configured to receive at least one of the vacuum residue stream or a second portion of the atmospheric residue stream as a feedstock, wherein the residue upgrading unit is configured to convert at least a portion of the feedstock to produce at least a middle distillate stream; a hydroprocessing unit comprising a hydrotreater and a hydrocracker, wherein the hydroprocessing unit is configured to receive and react at least a portion of the middle distillate stream produced by the residue upgrading unit with hydrogen to break carbon-carbon bonds of and remove sulfur-containing contaminants from the portion of the middle distillate stream; a hydrogenation unit comprising a hydrogenation catalyst comprising an active metal comprising at least one of platinum (Pt), palladium (Pd), or rhenium (Re), wherein the hydrogenation catalyst comprising a support comprising non-acidic amorphous alumina and a zeolite having at least one of titanium (Ti), zirconium (Zr), or hafnium (Hf) substituting aluminum atoms constituting a framework of the zeolite, wherein the hydrogenation unit is configured to receive at least a portion of the middle distillate stream from the hydroprocessing unit, wherein the hydrogenation unit is configured to hydrogenate at least the portion of the middle distillate stream in the presence of the hydrogenation catalyst to produce a hydrogenated middle distillate stream; and a steam cracking unit configured to receive steam and at least a portion of the hydrogenated middle distillate stream, wherein the steam cracking unit is configured to break carbon-carbon bonds of the portion of the hydrogenated middle distillate stream in the presence of steam to produce a pyrolysis gasoline, a pyrolysis oil, and a mixed gas product comprising light olefins, wherein at least one of the hydrogenation unit or the hydroprocessing unit is configured to receive at least one of a portion of the pyrolysis gasoline or a portion of the pyrolysis oil from the steam cracking unit.

### Definitions

As used in this disclosure, the term “stream” (and variations of this term, such as hydrocarbon stream, feed stream, product stream, and the like) may include one or more of various hydrocarbon compounds, such as straight chain, branched or cyclical alkanes, alkenes, alkadienes, alkynes, alkylaromatics, alkenyl aromatics, condensed and non-condensed di-, tri- and tetra-aromatics, and gases such as hydrogen and methane, C2+ hydrocarbons and may include various impurities.

The terms “zone” or “unit” refer to an area including one or more equipment or one or more sub-zones. Equipment may include one or more reactors or reactor vessels, heaters, heat exchangers, pipes, pumps, compressors, and controllers. Additionally, an equipment, such as reactor, dryer, or vessel, further may be included in one or more zones.

The term “crude oil” as used in this disclosure refers to petroleum extracted from geologic formations in its unrefined form. Crude oil suitable as the source material for the processes in this disclosure include, but are not limited to, Arabian Heavy, Arabian Light, Arabian Extra Light, other Gulf crudes, Brent, North Sea crudes, North and West African crudes, Indonesian, Chinese crudes, North or South American crudes, Russian and Central Asian crudes, or any combinations of these. The crude petroleum mixtures can be whole range crude oil or topped crude oil. As used in this disclosure, “crude oil” also refers to such mixtures that have undergone some pre-treatment, such as water-oil separation, gas-oil separation, desalting, stabilization, or any combinations of these. In certain implementations, crude oil refers to any of such mixtures having an API gravity (ASTM D287 standard) of 20°, greater than or equal to about 20°, greater than or equal to about 30°, greater than or equal to about 32°, greater than or equal to about 34°, greater than or equal to about 36°, greater than or equal to about 38°, greater than or equal to about 40°, greater than or equal to about 42° or greater than or equal to about 44°.

The term “condensates” refers to hydrocarbons separated from natural gas. As used in this disclosure, “condensates” also refers to mixtures that have undergone some pre-treatment, such as water-oil separation, gas-oil separation, desalting, stabilization, or any combinations of these. In certain implementations, condensates refer to any of such mixtures having an API gravity (ASTM D287 standard) of greater than or equal to about 45°, greater than or equal to about 50°, greater than or equal to about 60°, or greater than or equal to about 65°.

The acronym “LPG” as used in this disclosure refers to the well-known acronym for the term “liquefied petroleum gas”, and generally is a mixture of C3-C4 hydrocarbons. In certain implementations, these are also referred to as “light ends”.

As used in this disclosure, all boiling point ranges relative to hydrocarbon fractions derived from crude oil via atmospheric and/or vacuum distillation can refer to True Boiling Point (TBP) values obtained from a crude oil assay or a commercially acceptable equivalent.

As used in this disclosure, the term “true boiling point” (TBP) can mean a test method for determining the boiling point of a material which corresponds to ASTM D2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

The term “naphtha” as used in this disclosure refers to hydrocarbons having a nominal boiling range of about 20 degrees Celsius (° C.) to about 205° C., from about 20° C. to about 193° C., from about 20° C. to about 190° C., from about 20° C. to about 180° C., from about 20° C. to about 170° C., from about 32° C. to about 205° C., from about 32° C. to about 193° C., from about 32° C. to about 190° C., from about 32° C. to about 180° C., from about 32° C. to about 170° C., from about 36° C. to about 205° C., from about 36° C. to about 193° C., from about 36° C. to about 190° C., from about 36° C. to about 180° C., or from about 36° C. to about 170° C.

The term “light naphtha” as used in this disclosure refers to hydrocarbons having a nominal boiling range of from about 20° C. to about 110° C., from about 20° C. to about 100° C., from about 20° C. to about 90° C., from about 20° C. to about 88° C., from about 32° C. to about 110° C., from about 32° C. to about 100° C., from about 32° C. to about 90° C., from about 32° C. to about 88° C., from about 36° C. to about 110° C., from about 36° C. to about 100° C., from about 36° C. to about 90° C., or from about 36° C. to about 88° C.

The term “heavy naphtha” as used in this disclosure refers to hydrocarbons having a nominal boiling range of from about 90° C. to about 205° C., from about 90° C. to about 193° C., from about 90° C. to about 190° C., from about 90° C. to about 180° C., from about 90° C. to about 170° C., from about 93° C. to about 205° C., from about 93° C. to about 193° C., from about 93° C. to about 190° C., from about 93° C. to about 180° C., from about 93° C. to about 170° C., from about 100° C. to about 205° C., from about 100° C. to about 193° C., from about 100° C. to about 190° C., from about 100° C. to about 180° C., from about 100° C. to about 170° C., from about 110° C. to about 205° C., from about 110° C. to about 193° C., from about 110° C. to about 190° C., from about 110° C. to about 180° C., or from about 110° C. to about 170° C.

The term “heavy” as used in this disclosure is relative to “light” as used in this disclosure. Heavy compounds have a larger molecular weight and/or greater density in comparison to light compounds of the same type. For example, heavy naphtha has a larger molecular weight and/or greater density in comparison to light naphtha. Similarly, the term “heavier” as used in this disclosure refers to having a larger molecular weight and/or greater density. Similarly, the term “lighter” as used in this disclosure refers to having a smaller molecular weight and/or less density.

The modifying term “straight run” is used in this disclosure having its well-known meaning, that is, describing fractions derived directly from the atmospheric distillation unit, optionally subjected to steam stripping, without other refinery treatment such as hydroprocessing, fluid catalytic cracking or steam cracking. An example of this is “straight run naphtha” and its acronym “SRN” which accordingly refers to naphtha (defined above) that is derived directly from the atmospheric distillation unit and optionally subjected to steam stripping, as is well-known.

The term “kerosene” as used in this disclosure refers to hydrocarbons having a nominal boiling range of from about 160° C. to about 280° C., from about 160° C. to about 270° C., from about 160° C. to about 260° C., from about 170° C. to about 280° C., from about 170° C. to about 270° C., from about 170° C. to about 260° C., from about 180° C. to about 280° C., from about 180° C. to about 270° C., from about 180° C. to about 260° C., from about 190° C. to about 280° C., from about 190° C. to about 270° C., from about 190° C. to about 260° C., from about 193° C. to about 280° C., from about 193° C. to about 270° C., or from about 193° C. to about 260° C.

The term “light kerosene” as used in this disclosure refers to hydrocarbons having a nominal boiling range of from about 160° C. to about 250° C., from about 160° C. to about 235° C., from about 160° C. to about 230° C., from about 160° C. to about 225° C., from about 170° C. to about 250° C., from about 170° C. to about 235° C., from about 170° C. to about 230° C., from about 170° C. to about 225° C., from about 180° C. to about 250° C., from about 180° C. to about 235° C., from about 180° C. to about 230° C., from about 180° C. to about 225° C., from about 190° C. to about 250° C., from about 190° C. to about 235° C., from about 190° C. to about 230° C., or from about 190° C. to about 225° C.

The term “heavy kerosene” as used in this disclosure refers to hydrocarbons having a nominal boiling range of from about 225° C. to about 280° C., from about 225° C. to about 270° C., from about 225° C. to about 260° C., from about 230° C. to about 280° C., from about 230° C. to about 270° C., from about 230° C. to about 260° C., from about 235° C. to about 280° C., from about 235° C. to about 270° C., from about 235° C. to about 260° C., or from about 250° C. to about 280° C.

The term “atmospheric gas oil” and its acronym “AGO” as used in this disclosure refer to hydrocarbons having a nominal boiling range of from about 250° C. to about 400° C., from about 250° C. to about 380° C., from about 250° C. to about 370° C., from about 250° C. to about 360° C., from about 250° C. to about 340° C., from about 250° C. to about 320° C., from about 260° C. to about 400° C., from about 260° C. to about 380° C., from about 260° C. to about 370° C., from about 260° C. to about 360° C., from about 260° C. to about 340° C., from about 260° C. to about 320° C., from about 270° C. to about 400° C., from about 270° C. to about 380° C., from about 270° C. to about 370° C., from about 270° C. to about 360° C., from about 270° C. to about 340° C., or from about 270° C. to about 320° C.

The term “heavy atmospheric gas oil” and its acronym “H-AGO” as used in this disclosure in certain implementations refer to the heaviest cut of hydrocarbons in the AGO boiling range including the upper of about 3° C. to about 30° C. range (for example, for AGO having a range of from about 250° C. to about 360° C., the range of H-AGO includes an initial boiling point from about 330° C. to about 357° C. and an end boiling point of about 360° C.). For example, H-AGO can include hydrocarbons having a nominal boiling range of from about 290° C. to about 400° C., from about 290° C. to about 380° C., from about 290° C. to about 370° C., from about 310° C. to about 400° C., from about 310° C. to about 380° C., from about 310° C. to about 370° C., from about 330° C. to about 400° C., from about 330° C. to about 380° C., from about 330° C. to about 370° C., from about 340° C. to about 400° C., from about 340° C. to about 380° C., from about 340° C. to about 370° C., from about 350° C. to about 400° C., from about 350° C. to about 380° C., from about 350° C. to about 370° C., from about 360° C. to about 370° C., from about 365° C. to about 370° C., from about 290° C. to about 360° C., from about 310° C. to about 360° C., from about 330° C. to about 360° C., from about 340° C. to about 360° C., from about 350° C. to about 360° C., from about 355° C. to about 360° C., from about 290° C. to about 340° C., from about 310° C. to about 340° C., from about 330° C. to about 340° C., from about 335° C. to about 340° C., from about 290° C. to about 320° C., from about 310° C. to about 320° C., or from about 315° C. to about 320° C.

The term “medium atmospheric gas oil” and its acronym “M-AGO” as used in this disclosure in certain implementations in conjunction with H-AGO to refer to the remaining AGO after H-AGO is removed, that is, hydrocarbons in the AGO boiling range excluding the upper of about 3° C. to about 30° C. range (for example, for AGO having a range of from about 250° C. to about 360° C., the range of M-AGO includes an initial boiling point of about 250° C. and an end boiling point of from about 330° C. to about 357° C.). For example, M-AGO can include hydrocarbons having a nominal boiling range of from about 250° C. to about 365° C., from about 250° C. to about 355° C., from about 250° C. to about 335° C., from about 250° C. to about 315° C., from about 260° C. to about 365° C., from about 260° C. to about 355° C., from about 260° C. to about 335° C., from about 260° C. to about 315° C., from about 270° C. to about 365° C., from about 270° C. to about 355° C., from about 270° C. to about 335° C., or from about 270° C. to about 315° C.

In certain implementations, the term “middle distillate” is used with reference to one or more straight run fractions from the atmospheric distillation unit, for instance containing hydrocarbons having a nominal boiling range of from about 160° C. to about 400° C., from about 160° C. to about 380° C., from about 160° C. to about 370° C., from about 160° C. to about 360° C., from about 160° C. to about 340° C., from about 170° C. to about 400° C., from about 170° C. to about 380° C., from about 170° C. to about 370° C., from about 170° C. to about 360° C., from about 170° C. to about 340° C., from about 180° C. to about 400° C., from about 180° C. to about 380° C., from about 180° C. to about 370° C., from about 180° C. to about 360° C., from about 180° C. to about 340° C., from about 190° C. to about 400° C., from about 190° C. to about 380° C., from about 190° C. to about 370° C., from about 190° C. to about 360° C., from about 190° C. to about 340° C., from about 193° C. to about 400° C., from about 193° C. to about 380° C., from about 193° C. to about 370° C., from about 193° C. to about 360° C., or from about 193° C. to about 340° C. In implementations in which other terminology is used in this disclosure, the middle distillate fraction can also include all or a portion of AGO range hydrocarbons, all or a portion of kerosene, all or a portion of medium AGO range hydrocarbons, and/or all or a portion of heavy kerosene range hydrocarbons. In additional implementations, term “middle distillate” is used to refer to fractions from one or more integrated operations boiling in this range.

The term “atmospheric residue” and its acronym “AR” as used in this disclosure refer to the bottom hydrocarbons having an initial boiling point corresponding to the end point of the AGO range hydrocarbons and having an end point based on the characteristics of the crude oil feed.

The term “vacuum gas oil” and its acronym “VGO” as used in this disclosure refer to hydrocarbons having a nominal boiling range of from about 370° C. to about 565° C., from about 370° C. to about 550° C., from about 370° C. to about 540° C., from about 370° C. to about 530° C., from about 370° C. to about 510° C., from about 400° C. to about 565° C., from about 400° C. to about 550° C., from about 400° C. to about 540° C., from about 400° C. to about 530° C., from about 400° C. to about 510° C., from about 420° C. to about 565° C., from about 420° C. to about 550° C., from about 420° C. to about 540° C., from about 420° C. to about 530° C., or from about 420° C. to about 510° C.

The term “light vacuum gas oil” and its acronym “LVGO” as used in this disclosure refer to hydrocarbons having a nominal boiling range of from about 370° C. to about 425° C., from about 370° C. to about 415° C., from about 370° C. to about 405° C., from about 370° C. to about 395° C., from about 380° C. to about 425° C., from about 390° C. to about 425° C., or from about 400° C. to about 425° C.

The term “heavy vacuum gas oil” and its acronym “HVGO” as used in this disclosure refer to hydrocarbons having a nominal boiling range of from about 425° C. to about 565° C., from about 425° C. to about 550° C., from about 425° C. to about 540° C., from about 425° C. to about 530° C., from about 425° C. to about 510° C., from about 450° C. to about 565° C., from about 450° C. to about 550° C., from about 450° C. to about 540° C., from about 450° C. to about 530° C., or from about 450° C. to about 510° C.

The term “vacuum residue” and its acronym “VR” as used in this disclosure refer to the bottom hydrocarbons having an initial boiling point corresponding to the end point of the VGO range hydrocarbons and having an end point based on the characteristics of the crude oil feed.

The term “fuels” refers to crude oil-derived products used as energy carriers. Fuels commonly produced by oil refineries include, but are not limited to, gasoline, jet fuel, diesel fuel, fuel oil and petroleum coke. Unlike petrochemicals, which are a collection of well-defined compounds, fuels typically are complex mixtures of different hydrocarbon compounds.

The terms “kerosene fuel” and “kerosene fuel products” refer to fuel products used as energy carriers, such as jet fuel or other kerosene range fuel products (and precursors for producing such jet fuel or other kerosene range fuel products). Examples of kerosene fuel include, but are not limited to, kerosene fuel products meeting Jet A or Jet A-1 jet fuel specifications.

The terms “diesel fuel” and “diesel fuel products” refer to fuel products used as energy carriers suitable for compression-ignition engines (and precursors for producing such fuel products). An example of diesel fuel includes, but is not limited to, ultra-low sulfur diesel compliant with Euro V diesel standards.

The term “aromatic hydrocarbons” or “aromatics” is well-known in the art. Accordingly, the term “aromatic hydrocarbon” relates to cyclically conjugated hydrocarbons with a stability (due to delocalization) that is significantly greater than that of a hypothetical localized structure (for example, Kekule structure). “Aromatic hydrocarbons” or “aromatics” can refer to cyclically conjugated hydrocarbons having a single ring or multiple rings. A common method for determining aromaticity of a given hydrocarbon is the observation of diatropicity in its proton nuclear magnetic resonance (H-NMR) spectrum, for example the presence of chemical shifts in the range of from about 7.2 parts per million (ppm) to about 7.3 ppm for benzene ring protons.

As used in this disclosure, the term “aromatic products” includes C6-C8 aromatics, such as benzene, toluene, mixed xylenes (commonly referred to as BTX), or benzene, toluene, ethylbenzene and mixed xylenes (commonly referred to as BTEX), and any combinations of these. These aromatic products (referred to in combination or in the alternative as BTX/BTEX for convenience) have a premium chemical value.

The term “wild naphtha” is used in this disclosure to refer to naphtha products derived from hydroprocessing units such as distillate hydrotreating units, vacuum gas oil hydroprocessing units and/or vacuum residue hydroprocessing units.

The term “unconverted oil” and its acronym “UCO”, is used in this disclosure having its known meaning, and refers to a highly paraffinic and naphthenic fraction from a hydrocracker with a low nitrogen, sulfur, and nickel content and including hydrocarbons having a nominal boiling range with an initial boiling point corresponding to the end point of the AGO range hydrocarbons, in certain implementations, the initial boiling point in the range of from about 340° C. to about 370° C., for instance, about 340° C., about 360° C., or about 370° C., and an end point in the range of from about 510° C. to about 565° C., for instance, about 540° C., about 550° C., or about 565° C. UCO is also known in the industry by other synonyms including “hydrowax”.

The term “C#hydrocarbons” or “C#”, is used in this disclosure having its well-known meaning, that is, where “#” is an integer value, and means hydrocarbons having that value of carbon atoms. The term “C#+ hydrocarbons” or “C#+” refers to hydrocarbons having that value or more carbon atoms. The term “C#-hydrocarbons” or “C#-” refers to hydrocarbons having that value or less carbon atoms. Similarly, ranges are also set forth, for instance, C1-C3 means a mixture comprising C1, C2, and C3.

The term “petrochemicals” or “petrochemical products” refers to chemical products derived from crude oil that are not used as fuels. Petrochemical products include olefins and aromatics that are used as a basic feedstock for producing chemicals and polymers. Examples of typical olefinic petrochemical products include, but are not limited to, ethylene, propylene, butadiene, butylene-1, isobutylene, isoprene, cyclopentadiene, and styrene. Examples of typical aromatic petrochemical products include, but are not limited to, benzene, toluene, xylene, and ethyl benzene.

The term “olefin” is used in this disclosure having its well-known meaning, that is, unsaturated hydrocarbons containing at least one carbon-carbon double bond. In plural, the term “olefins” means a mixture comprising two or more unsaturated hydrocarbons containing at least one carbon-carbon double bond. In certain implementations, the term “olefins” relates to a mixture comprising two or more of ethylene, propylene, butadiene, butylene-1, isobutylene, isoprene, and cyclopentadiene.

The term “light olefins” as in this disclosure in certain implementations refer to olefins having a carbon number of 2-4 (C2-C4), such as ethylene, propylene, and butylene.

The term “pyrolysis gasoline” and its abbreviated form “py-gas” are used in this disclosure having their well-known meaning, that is, steam cracking products in the range of C5 to C9, for instance having a nominal boiling range with an end boiling point of about 204.4° C., in certain implementations up to about 148.9° C.

The term “pyrolysis oil” and its abbreviated form “py-oil” are used in this disclosure having their well-known meaning, that is, a heavy oil fraction, C10+, that is derived from steam cracking.

The term “light pyrolysis oil” and its acronym “LPO” as used in this disclosure in certain implementations refer to pyrolysis oil having a nominal boiling range with an end boiling point of about 440° C., about 450° C., about 460° C., or about 470° C.

The term “heavy pyrolysis oil” and its acronym “HPO” as used in this disclosure in certain implementations refer to pyrolysis oil having a nominal boiling range with an initial boiling point of about 440° C., about 450° C., about 460° C., or about 470° C.

The term “light cycle oil” and its acronym “LCO” as used in this disclosure refers to the light cycle oil produced by FCC units. The nominal boiling range for this stream is, for example, in the range of from about 215° C. to about 350° C., from about 216° C. to about 350° C., from about 220° C. to about 350° C., from about 215° C. to about 343° C., from about 216° C. to about 343° C., from about 220° C. to about 343° C., from about 215° C. to about 330° C., from about 216° C. to about 330° C., or from about 220° C. to about 330° C. LCO, directly from FCC separation or after hydrotreating, is conventionally used in diesel blends depending on the diesel specifications, or as a cutter to the fuel oil tanks for a reduction in the viscosity and sulfur contents.

The term “hydrocracking” as used in this disclosure has its well-known meaning, that is, a catalytic cracking process assisted by the presence of hydrogen gas. In hydrocracking, hydrogen is used to break carbon-carbon bonds to produce saturated hydrocarbons. Depending on reaction conditions (such as temperature, pressure, and catalyst activity) hydrocracking products can range from ethane, LPGs, to heavier hydrocarbons, such as isoparaffins. Hydrocracking can be capable of rearranging and breaking hydrocarbon chains, as well as adding hydrogen to aromatics and olefins to produce naphthenes (cycloalkanes) and alkanes. The hydrocracking process can depend on the nature of the feedstock and relative rates of two competing reactions: hydrogenation and cracking.

The term “hydrotreating” as used in this disclosure has its well-known meaning, that is a catalytic chemical process to remove sulfur from hydrocarbon streams, such as natural gas and refined petroleum products (for example, gasoline, jet fuel, kerosene, diesel fuel, and fuel oil). Hydrotreating is sometimes referred to as hydrodesulfurization or hydrotreatment. The term “hydroprocessing” as used in this disclosure refers to processing that includes both hydrocracking and hydrotreating.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the terms “about” and “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A method comprising:
fractionating, by an atmospheric column, a crude oil stream obtained from a subterranean formation to separate at least an atmospheric residue stream from the crude oil stream;
fractionating, by a vacuum column, at least a portion of the atmospheric residue stream to separate at least a vacuum residue stream from at least the portion of the atmospheric residue stream;
converting, by a residue upgrading unit, a feedstock comprising at least one of the vacuum residue stream or a second portion of the atmospheric residue stream to produce at least a middle distillate stream;
hydrogenating, by a hydrogenation unit comprising a hydrogenation catalyst, at least a portion of the middle distillate stream to produce a hydrogenated middle distillate stream;
breaking carbon-carbon bonds of at least a portion of the hydrogenated middle distillate stream in the presence of steam to produce a pyrolysis gasoline, a pyrolysis oil, and a mixed gas product comprising light olefins;
recycling at least of a portion of the pyrolysis gasoline, at least of a portion of the pyrolysis oil, or both to the hydrogenation unit; and
hydrogenating, by the hydrogenation unit, at least the portion of the pyrolysis gasoline, at least the portion of the pyrolysis oil, or both.

2. The method of claim 1, comprising subjecting the portion of the middle distillate stream produced by the residue upgrading unit to hydroprocessing prior to hydrogenating the portion of the middle distillate stream.

3. The method of claim 1, wherein the portion of the middle distillate stream that is hydrogenated by the hydrogenation unit has an aromatics content in a range of from about 10 weight percent (wt. %) to 100 wt. %, and the hydrogenated middle distillate stream is substantially free of aromatics.

4. The method of claim 1, wherein the hydrogenation catalyst comprises an active metal comprising at least one of platinum (Pt), palladium (Pd), or rhenium (Re), wherein the hydrogenation catalyst comprises a support comprising non-acidic amorphous alumina and a zeolite having at least one of titanium (Ti), zirconium (Zr), or hafnium (Hf) substituting aluminum atoms constituting a framework of the zeolite.

5. The method of claim 1, wherein fractionating at least the portion of the atmospheric residue stream by the vacuum column produces at least a vacuum gas oil stream, and the method comprises:
subjecting at least a portion of the vacuum gas oil stream to hydroprocessing or fluid catalytic cracking to produce a second middle distillate stream; and
hydrogenating, by the hydrogenation unit, at least a portion of the second middle distillate stream.

6. The method of claim 1, wherein the portion of the middle distillate stream is hydrogenated by the hydrogenation unit at:
a hydrogen partial pressure in a range of from about 5,000 kilopascals gauge (kPag) to about 15,000 kPag;
a hydrogenation temperature in a range of from about 250 degrees Celsius (° C.) to about 400° C.;
a liquid hourly space velocity on a fresh feed basis relative to the hydrogenation catalyst in a range of from about 0.1 per hour (h⁻¹) to about 5.0 h⁻¹; and
a hydrogen-to-oil feed ratio in a range of from about 100 standard liters per liter (StL/L) to about 1,500 StL/L.

7. The method of claim 1, comprising, prior to hydrogenating the portion of the middle distillate stream:
mixing the portion of the middle distillate stream with an excess of hydrogen to produce a mixture of hydrogen-enriched middle distillates and undissolved hydrogen; and
removing at least a portion of the undissolved hydrogen from the mixture to produce a hydrogen-enriched middle distillate stream, wherein hydrogenating at least the portion of the middle distillate stream comprises hydrogenating at least a portion of the hydrogen-enriched middle distillate stream.

8. The method of claim 1, comprising breaking carbon-carbon bonds of at least a second portion of the middle distillate stream in the presence of steam to produce additional light olefins.

9. The method of claim 1, comprising subjecting at least one of the portion of the pyrolysis gasoline or the portion of the pyrolysis oil to hydroprocessing prior to recycling at least one of the portion of the pyrolysis gasoline or the portion of the pyrolysis oil to the hydrogenation unit.

10. The method of claim 1, comprising recycling a second portion of the pyrolysis oil to the residue upgrading unit.

11. A system for refining crude oil obtained from a subterranean formation, the system comprising:
an atmospheric column configured to receive the crude oil and separate at least an atmospheric residue stream from the crude oil;
a vacuum column configured to receive at least a portion of the atmospheric residue stream from the atmospheric column and separate at least a vacuum residue stream from at least the portion of the atmospheric residue stream;
a residue upgrading unit configured to receive at least one of the vacuum residue stream or a second portion of the atmospheric residue stream as a feedstock, wherein the residue upgrading unit is configured to convert at least a portion of the feedstock to produce at least a middle distillate stream;
a hydrogenation unit comprising a hydrogenation catalyst comprising an active metal comprising at least one of platinum (Pt), palladium (Pd), or rhenium (Re), wherein the hydrogenation catalyst comprising a support comprising non-acidic amorphous alumina and a zeolite having at least one of titanium (Ti), zirconium (Zr), or hafnium (Hf) substituting aluminum atoms constituting a framework of the zeolite, wherein the hydrogenation unit is configured to receive at least a portion of the middle distillate stream from the residue upgrading unit, wherein the hydrogenation unit is configured to hydrogenate at least the portion of the middle distillate stream in the presence of the hydrogenation catalyst to produce a hydrogenated middle distillate stream; and
a steam cracking unit configured to receive steam and at least a portion of the hydrogenated middle distillate stream, wherein the steam cracking unit is configured to break carbon-carbon bonds of the portion of the hydrogenated middle distillate stream in the presence of steam to produce a pyrolysis gasoline, a pyrolysis oil, and a mixed gas product comprising light olefins, wherein the hydrogenation unit is configured to receive and hydrogenate at least one of a portion of the pyrolysis gasoline or a portion of the pyrolysis oil from the steam cracking unit.

12. The system of claim 11, comprising a hydroprocessing unit comprising a hydrotreater and a hydrocracker, wherein the hydroprocessing unit is configured to receive and react at least the portion of the middle distillate stream produced by the residue upgrading unit with hydrogen to break carbon-carbon bonds of and remove sulfur-containing contaminants from the portion of the middle distillate stream upstream of the hydrogenation unit.

13. The system of claim 12, wherein the vacuum column is configured to at least a vacuum gas oil stream from the portion of the atmospheric residue stream, wherein the hydroprocessing unit is configured to receive and react at least a portion of the vacuum gas oil with hydrogen to break carbon-carbon bonds of and remove sulfur-containing contaminants from the portion of the vacuum gas oil.

14. The system of claim 12, wherein the portion of the middle distillate stream that is hydrogenated by the hydrogenation unit has an aromatics content in a range of from about 10 weight percent (wt. %) to 100 wt. %, and the hydrogenated middle distillate stream is substantially free of aromatics.

15. The system of claim 12, wherein the portion of the middle distillate stream that is hydrogenated by the hydrogenation unit comprises at least about 10 weight percent (wt. %) aromatics, and the hydrogenated middle distillate stream comprises less than about 1 wt. % aromatics.

16. The system of claim 12, comprising the middle distillate stream, wherein:
a hydrogen partial pressure within the hydrogenation unit is in a range of from about 5,000 kilopascals gauge (kPag) to about 15,000 kPag;
a hydrogenation temperature within the hydrogenation unit is in a range of from about 250 degrees Celsius (° C.) to about 400° C.;
a liquid hourly space velocity on a fresh feed basis relative to the hydrogenation catalyst of the portion of the middle distillate stream within the hydrogenation unit is in a range of from about 0.1 per hour (h⁻¹) to about 5.0 h⁻¹; and
a hydrogen-to-oil feed ratio within the hydrogenation unit is in a range of from about 100 standard liters per liter (StL/L) to about 1,500 StL/L.

17. The system of claim 12, wherein the steam cracking unit is configured to receive and break carbon-carbon bonds of at least a second portion of the middle distillate stream in the presence of steam to produce additional light olefins.

18. The system of claim 12, wherein the hydroprocessing unit is configured to receive and react at least one of the portion of the pyrolysis gasoline or the portion of the pyrolysis oil produced by the steam cracking unit with hydrogen to break carbon-carbon bonds of and remove sulfur-containing contaminants from at least one of the portion of the pyrolysis gasoline or the portion of the pyrolysis oil, upstream of the hydrogenation unit.

19. The system of claim 12, wherein the residue upgrading unit is configured to receive at least a second portion of the pyrolysis oil from the steam cracking unit.

20. A system comprising:
a vacuum distillation tower configured to receive an atmospheric residue stream from an atmospheric distillation tower, wherein the vacuum distillation tower is configured to fractionate the atmospheric residue stream to produce at least a vacuum residue stream;
a residue upgrading unit configured to receive at least one of the vacuum residue stream or a second portion of the atmospheric residue stream as a feedstock, wherein the residue upgrading unit is configured to convert at least a portion of the feedstock to produce at least a middle distillate stream;
a hydroprocessing unit comprising a hydrotreater and a hydrocracker, wherein the hydroprocessing unit is configured to receive and react at least a portion of the middle distillate stream produced by the residue upgrading unit with hydrogen to break carbon-carbon bonds of and remove sulfur-containing contaminants from the portion of the middle distillate stream;
a hydrogenation unit comprising a hydrogenation catalyst comprising an active metal comprising at least one of platinum (Pt), palladium (Pd), or rhenium (Re), wherein the hydrogenation catalyst comprising a support comprising non-acidic amorphous alumina and a zeolite having at least one of titanium (Ti), zirconium (Zr), or hafnium (Hf) substituting aluminum atoms constituting a framework of the zeolite, wherein the hydrogenation unit is configured to receive at least a portion of the middle distillate stream from the hydroprocessing unit, wherein the hydrogenation unit is configured to hydrogenate at least the portion of the middle distillate stream in the presence of the hydrogenation catalyst to produce a hydrogenated middle distillate stream; and
a steam cracking unit configured to receive steam and at least a portion of the hydrogenated middle distillate stream, wherein the steam cracking unit is configured to break carbon-carbon bonds of the portion of the hydrogenated middle distillate stream in the presence of steam to produce a pyrolysis gasoline, a pyrolysis oil, and a mixed gas product comprising light olefins, wherein at least one of the hydrogenation unit or the hydroprocessing unit is configured to receive at least one of a portion of the pyrolysis gasoline or a portion of the pyrolysis oil from the steam cracking unit.
